(19) United States
(12) Patent Application Publication
(10) Pub. No.: US 2016/0156760 A1
(43) Pub. Date: Jun. 2, 2016

(54) Mobile terminal alarm method and device, and mobile terminal

(71) Applicant: ZTE Corporation, Shenzhen, Guangdong (CN)

(72) Inventors: Fengyu ZHANG, Shenzhen (CN); Xuehong WANG, Shenzhen (CN)

(21) Appl. No.: 14/771,609

(22) PCT Filed: Aug. 26, 2013
(86) PCT No.: PCT/CN2013/082314

§ 371 Date: Aug. 31, 2015

(30) Foreign Application Priority Data
Mar. 1, 2013 (CN) 201310066675.1

(51) Int. Cl. H04M 1/67; H04W 12/12

(52) U.S. Cl. CPC H04M 1/67; H04W 12/12

(57) ABSTRACT

Disclosed is an alarm method for a mobile terminal. After a pre-alarm function of the mobile terminal is enabled, pre-alarm information is generated and output when an input operation performed on the mobile terminal is detected. Moreover, an alarm device for a mobile terminal, and the mobile terminal provided with the alarm device are disclosed. By the technical solution of the disclosure, automatic pre-alarm can be implemented for a smart mobile terminal; when the mobile terminal is operated accidentally, a notification can be given to a user at once, thus the security of the mobile terminal is ensured, and the user experience is improved; moreover, the structure of the mobile terminal does not need to be changed, and the production cost can be saved.

### TECHNICAL FIELD

The present disclosure relates to alarm technology, and more particularly to an alarm method and an alarm device for a mobile terminal, and the mobile terminal.

### BACKGROUND

With the rapid development of the communication technology, user equipment becomes more and more popular. Particularly, a smart terminal, such as a smart phone, is more popular with users due to its fastness and convenience. Generally, the private information of a user, such as a bank card number and an ID number of a family member, is collected in the smart phone, which may bring convenience to the user but may also cause a security problem. When the smart phone is stolen or the private information is snooped, a loss may be caused to the user.

At present, the following methods are adopted to ensure the security of information in the smart phone: a fingerprint identifier is built-in in the smart phone and the smart phone is started via the fingerprint of the user; or, the communication content, such as conversation and a short message, is encrypted and decrypted. Although the security of the information in the smart phone can be protected, the production cost of the smart phone may be increased undoubtedly by methods of arranging a fingerprint identifier in the smart phone which try to change the structure of the smart phone to achieve the aim of protecting the security of information. In terms of the method for ensuring the security by encrypting and decrypting the conversation content, interference information is usually added in a short message and cannot be found until the short message is decrypted successfully, thus, the waste of software and hardware processing resources of the smart phone is caused inevitably.

### SUMMARY

In view of this, the main objective of the embodiments of the present disclosure is to provide an alarm method and device for a mobile terminal, and the mobile terminal, so as to implement automatic pre-alarm for a smart mobile terminal without changing the structure of the smart mobile terminal, improve the user experience, and save the production cost and the processing resources.

To this end, the technical solution of the embodiments of the present disclosure is implemented as follows:

An embodiment of the present disclosure provides an alarm method for a mobile terminal, after a pre-alarm function of the mobile terminal is enabled, the method includes:

when it is detected that an input operation is performed on the mobile terminal, pre-alarm information is generated and output.

In the solution, before the pre-alarm function of the mobile terminal is enabled, the method may further include that the pre-alarm function is set for the mobile terminal.

In the solution, the step that the pre-alarm function is set for the mobile terminal may include:

a pre-alarm function menu is created, a pre-alarm function switch is set in the pre-alarm function menu, and a pre-alarm output way is set, wherein the pre-alarm information is different from a call or short message reminder message of the mobile terminal.

In the solution, the step that when it is detected that input operation is performed on the mobile terminal, pre-alarm information is generated and output may include:

when it is detected that a touch screen or a function key of the mobile terminal is pressed or it is detected that an enabling instruction is input for an application of the mobile terminal, pre-alarm information is generated, and the pre-alarm information is output according to the set pre-alarm output way.

In the solution, the method may further include:

a pre-alarm area is set on the touch screen of the mobile terminal;

when the pre-alarm function is not enabled, the pre-alarm function is enabled when it is detected that the pre-alarm area is clicked; when the pre-alarm function is enabled, the pre-alarm function is disabled when it is detected that the pre-alarm area is clicked; or, clicking times of continuously clicking the pre-alarm area is counted, and the pre-alarm function is enabled or disabled by counting the clicking times.

An embodiment of the present disclosure further provides an alarm device for a mobile terminal, and the device includes a processing module and an output module, wherein

the processing module is configured to enable a pre-alarm function of the mobile terminal, and generate pre-alarm information when detecting that an input operation is performed on the mobile terminal; and

the output module is configured to output the pre-alarm information.

In the solution, the device may further include a setting module which is configured to set the pre-alarm function for the mobile terminal.

In the solution, the setting module may be further configured to create a pre-alarm function menu, set a pre-alarm function switch in the pre-alarm function menu, and set a pre-alarm output way, wherein the pre-alarm information is different from a call or short message reminder message of the mobile terminal.

In the solution, the processing module may be configured to generate the pre-alarm information when detecting that a touch screen or a function key of the mobile terminal is pressed or detecting that an enabling instruction is input for an application of the mobile terminal;

and correspondingly, the output module may be configured to output the pre-alarm information according to the set pre-alarm output way.

In the solution, the setting module may be further configured to set a pre-alarm area on the touch screen of the mobile terminal; and

correspondingly, when the pre-alarm function is not enabled, the processing module enables the pre-alarm function when detecting that the pre-alarm area is clicked; when the pre-alarm function is enabled, the processing module disables the pre-alarm function when detecting that the pre-alarm area is clicked; or, the processing module counts clicking times of continuously clicking the pre-alarm area, and enables or disables the pre-alarm function by counting the clicking times.

An embodiment of the present disclosure further provides a mobile terminal, which is provided with the alarm device in the above solutions.

According to the alarm method and the alarm device for a mobile terminal, and the mobile terminal in which the alarm device is arranged provided by the embodiments of the present disclosure, the pre-alarm function is set to be enabled; when it is detected that the touch screen or the function key of the mobile terminal is pressed or it is detected that an enabling instruction is input for an application of the mobile terminal, the pre-alarm information is generated; and the pre-alarm information is output according to the set pre-alarm output way. Through the technical solution of the embodiments of the present disclosure, automatic pre-alarm can be implemented for a smart mobile terminal; when the mobile terminal is operated accidentally, a notification can be given to a user at once, so that the security of the mobile terminal is ensured, and the user experience is improved; moreover, the structure of the mobile terminal does not need to be changed, and the production cost can be saved.

### BRIEF DESCRIPTION OF THE DRAWINGS

FIG. 1 is a schematic diagram showing the flow of an alarm method for a mobile terminal according to an embodiment of the present disclosure; and

FIG. 2 is a schematic diagram showing the composition structure of an alarm device for a mobile terminal according to an embodiment of the present disclosure.

### DETAILED DESCRIPTION

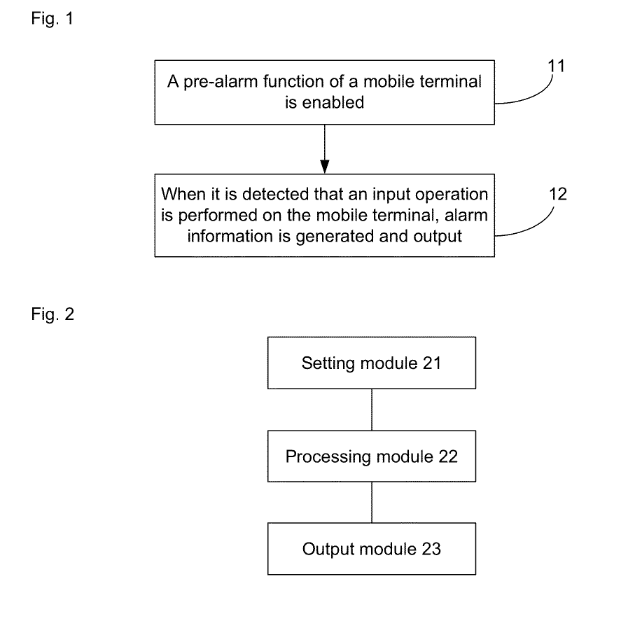

An embodiment of the present disclosure provides an alarm method for a mobile terminal, as shown in FIG. 1, the method includes:

Step 11: A pre-alarm function of the mobile terminal is enabled.

Here, the pre-alarm function is set for the mobile terminal in advance. The step that the pre-alarm function is set for the mobile terminal may include: a pre-alarm function menu is created, a pre-alarm function is set to be enabled in the pre-alarm function menu, and a pre-alarm output way is set, wherein the pre-alarm output way includes an audio way, a video way or a combined way of audio and video. The mobile terminal includes a smart phone and a feature phone.

A pre-alarm area is set on a touch screen of the mobile terminal; when the pre-alarm function is not enabled, the pre-alarm function is enabled when it is detected that the pre-alarm area is clicked; when the pre-alarm function is enabled, the pre-alarm function is disabled when it is detected that the pre-alarm area is clicked; or, clicking times of continuously clicking the pre-alarm area is counted, and the pre-alarm function is enabled or disabled by counting the click times, for example, the pre-alarm function is enabled if the counted times is an odd number and the pre-alarm function is disabled if the counted times is an even number.

Step 12: When it is detected that an input operation is performed on the mobile terminal, alarm information is generated and output.

In the embodiment, the pre-alarm information includes at least one of the following ways: ringtone, vibration and touch panel glittering. The pre-alarm information is different from a call or short message reminder message of the mobile terminal.

A pre-alarm identifier 1 represents that the pre-alarm function of the smart phone is enabled, and a pre-alarm identifier 0 represents that the pre-alarm function is disenabled.

When the pre-alarm function is enabled, namely, the pre-alarm identifier is 1, pre-alarm information, such as ringtone, is generated and output when it is detected that the touch screen or the function key of the mobile terminal is pressed.

Or, when the pre-alarm function is enabled, namely, the pre-alarm identifier is 1, pre-alarm information, such as ringtone, may be generated and output when it is detected that an enabling instruction is input for an application of the mobile terminal, such as a message box and a phone book. For example, when a message box button or a phone book button is clicked, pre-alarm information such as ringtone is generated and output.

After the pre-alarm function is enabled, the screen of the mobile terminal is locked if it is detected that no input operation is performed on the mobile terminal within a preset time, wherein the preset time can be adjusted according to the frequency of utilization of the mobile terminal.

Based on the alarm method for a mobile terminal, an embodiment of the present disclosure further provides an alarm device for a mobile terminal. FIG. 2 is a schematic diagram showing the composition structure of an alarm device for a mobile terminal, as shown in FIG. 2, the device includes a processing module 22 and an output module 23, wherein

the processing module 22 is configured to enable a pre-alarm function of the mobile terminal, and generate pre-alarm information when detecting that an input operation is performed on the mobile terminal; and

the output module 23 is configured to output the pre-alarm information.

Preferably, the device further includes a setting module 21, wherein the setting module 21 is configured to set a pre-alarm function for the mobile terminal and is further configured to create a pre-alarm function menu, set a pre-alarm function switch in the pre-alarm function menu and set a pre-alarm output way; the pre-alarm information is different from a call or a short message reminder message of the mobile terminal.

The processing module 22 is configured to enable the pre-alarm function of the mobile terminal, and generate pre-alarm information when detecting that a touch screen or a function key of the mobile terminal is pressed or an enabling instruction is input for an application of the mobile terminal, such as clicking a message box button or a phone book button;

and correspondingly, the output module 23 is configured to output the pre-alarm information according to the set pre-alarm output way.

The pre-alarm output way includes: an audio way, a video way or a combined way of audio and video; and correspondingly, the pre-alarm information includes at least one of the following ways: ringtone, vibration and touch panel glittering.

The setting module 21 is further configured to set a pre-alarm area in the pre-alarm function menu; correspondingly, when the pre-alarm function is not enabled, the pre-alarm function is enabled when the processing module 22 detects that the pre-alarm area is clicked; when the pre-alarm function is enabled, the pre-alarm function is disabled when the processing module 22 detects that the pre-alarm area is clicked; or, the processing module 22 counts clicking times of continuously clicking the pre-alarm area and enables or disables the pre-alarm function by counting the clicking times. For example, the pre-alarm function is enabled when the clicking times is an odd number and is disabled when the clicking times is an even number.

After the pre-alarm function is enabled, the screen of the mobile terminal is locked if the processing module 22 detects that no input operation is performed on the mobile terminal within a preset time, wherein the preset time is preset in the processing module 22 and can be adjusted according to the frequency of utilization of the mobile terminal.

In the actual application, the setting module 21, the processing module 22 and the output module 23 can be implemented by the Central Processing Unit (CPU), the Digital Signal Processor (DSP) or the Field Programmable Gate Array (FPGA) and the like; and the CPU, DSP and FPGA can be arranged in the mobile terminal.

Those skilled in the art shall understand that the implementing functions of each processing module in the alarm device for a mobile terminal in FIG. 2 can be understood in reference to the related description of the alarm method for a mobile terminal. Those skilled in the art shall understand that the function of each processing unit of the alarm device for a mobile terminal in FIG. 2 can be implemented either by a program running on a processor or by a specific logic circuit.

The present disclosure further records a mobile terminal, including the alarm device in FIG. 2.

According to the alarm method and the alarm device for a mobile terminal, and the mobile terminal provided by the embodiments of the present disclosure, a pre-alarm function is set to be enabled at first, and after the pre-alarm function of the mobile terminal is enabled, when it is detected that the touch screen or the function key of the mobile terminal is pressed or it is detected that an enabling instruction is input for an application of the mobile terminal, pre-alarm information is generated, and the pre-alarm information is output according to a set pre-alarm output way to remind a user that the mobile terminal is being turned on. Through the technical solution of the embodiments of the present disclosure, automatic pre-alarm can be implemented on the smart mobile terminal without changing the structure of the smart mobile terminal, thereby saving the production cost and the processing resources, and improving the user experience.

Provided with the alarm device, the mobile terminal in the embodiment of the present disclosure also has the technical effects.

The above are only the preferred embodiments of the present disclosure, and are not intended to limit the scope of protection of the claims of the present disclosure.

1. An alarm method for a mobile terminal, after a pre-alarm function of the mobile terminal is enabled, the method comprising:
generating and outputting pre-alarm information when detecting that an input operation is performed on the mobile terminal.

2. The alarm method for a mobile terminal according to claim 1, before the pre-alarm function of the mobile terminal is enabled, the method further comprising:
setting the pre-alarm function for the mobile terminal.

3. The alarm method for a mobile terminal according to claim 1, wherein setting the pre-alarm function for the mobile terminal comprises:
creating a pre-alarm function menu, setting a pre-alarm function switch in the pre-alarm function menu and setting a pre-alarm output way;
wherein the pre-alarm information is different from a call or short message reminder message of the mobile terminal.

4. The alarm method for a mobile terminal according to claim 3, wherein generating and outputting pre-alarm information when detecting that the input operation is performed on the mobile terminal comprises:
when detecting that a touch screen or a function key of the mobile terminal is pressed or detecting that an enabling instruction is input for an application of the mobile terminal, generating the pre-alarm information, and outputting the pre-alarm information according to the set pre-alarm output way.

5. The alarm method for a mobile terminal according to claim 1, further comprising:
setting a pre-alarm area on a touch screen of the mobile terminal; and
when the pre-alarm function is not enabled, enabling the pre-alarm function when detecting that the pre-alarm area is clicked; when the pre-alarm function is enabled, disabling the pre-alarm function when detecting that the pre-alarm area is clicked; or, counting clicking times of continuously clicking the pre-alarm area, and enabling or disabling the pre-alarm function by counting the clicking times.

6. An alarm device for a mobile terminal, comprising a processing module and an output module, wherein
the processing module is configured to enable a pre-alarm function of the mobile terminal, and generate pre-alarm information when detecting that an input operation is performed on the mobile terminal; and
the output module is configured to output the pre-alarm information.

7. The alarm device for a mobile terminal according to claim 6, further comprising a setting module which is configured to set the pre-alarm function for the mobile terminal.

8. The alarm device for a mobile terminal according to claim 6, wherein the setting module is further configured to create a pre-alarm function menu, set a pre-alarm function switch in the pre-alarm function menu, and set a pre-alarm output way,
wherein the pre-alarm information is different from a call or short message reminder message of the mobile terminal.

9. The alarm device for a mobile terminal according to claim 8, wherein the processing module is configured to generate the pre-alarm information when detecting that a touch screen or a function key of the mobile terminal is pressed or detecting that an enabling instruction is input for an application of the mobile terminal;
and correspondingly, the output module is configured to output the pre-alarm information according to the set pre-alarm output way.

10. The alarm device for a mobile terminal according to claim 6, wherein the setting module is further configured to set a pre-alarm area on a touch screen of the mobile terminal; and
correspondingly, when the pre-alarm function is not enabled, the processing module enables the pre-alarm function when detecting that the pre-alarm area is clicked; when the pre-alarm function is enabled, the processing module disables the pre-alarm function when detecting that the pre-alarm area is clicked; or, the processing module counts clicking times of continuously clicking the pre-alarm area, and enables or disables the pre-alarm function by counting the clicking times.

11. A mobile terminal, provided with the alarm device which comprises:
a processing module configured to enable a pre-alarm function of the mobile terminal, and generate pre-alarm information when detecting that an input operation is performed on the mobile terminal; and
an output module configured to output the pre-alarm information.

12. The alarm method for a mobile terminal according to claim 2, wherein setting the pre-alarm function for the mobile terminal comprises:
creating a pre-alarm function menu, setting a pre-alarm function switch in the pre-alarm function menu and setting a pre-alarm output way;
wherein the pre-alarm information is different from a call or short message reminder message of the mobile terminal.

13. The alarm method for a mobile terminal according to claim 12, wherein generating and outputting pre-alarm information when detecting that the input operation is performed on the mobile terminal comprises:
when detecting that a touch screen or a function key of the mobile terminal is pressed or detecting that an enabling instruction is input for an application of the mobile terminal, generating the pre-alarm information, and outputting the pre-alarm information according to the set pre-alarm output way.

14. The alarm device for a mobile terminal according to claim 7, wherein the setting module is further configured to create a pre-alarm function menu, set a pre-alarm function switch in the pre-alarm function menu, and set a pre-alarm output way,
wherein the pre-alarm information is different from a call or short message reminder message of the mobile terminal.

15. The alarm device for a mobile terminal according to claim 14, wherein the processing module is configured to generate the pre-alarm information when detecting that a touch screen or a function key of the mobile terminal is pressed or detecting that an enabling instruction is input for an application of the mobile terminal;
and correspondingly, the output module is configured to output the pre-alarm information according to the set pre-alarm output way.

16. The mobile terminal according to claim 11, wherein the alarm device further comprises a setting module which is configured to set the pre-alarm function for the mobile terminal.

17. The mobile terminal according to claim 11, wherein the setting module is further configured to create a pre-alarm function menu, set a pre-alarm function switch in the pre-alarm function menu, and set a pre-alarm output way,
wherein the pre-alarm information is different from a call or short message reminder message of the mobile terminal.

18. The mobile terminal according to claim 16, wherein the setting module is further configured to create a pre-alarm function menu, set a pre-alarm function switch in the pre-alarm function menu, and set a pre-alarm output way,
wherein the pre-alarm information is different from a call or short message reminder message of the mobile terminal.

19. The mobile terminal according to claim 17, wherein the processing module is configured to generate the pre-alarm information when detecting that a touch screen or a function key of the mobile terminal is pressed or detecting that an enabling instruction is input for an application of the mobile terminal;
and correspondingly, the output module is configured to output the pre-alarm information according to the set pre-alarm output way.

20. The mobile terminal according to claim 11, wherein the setting module is further configured to set a pre-alarm area on a touch screen of the mobile terminal; and
correspondingly, when the pre-alarm function is not enabled, the processing module enables the pre-alarm function when detecting that the pre-alarm area is clicked; when the pre-alarm function is enabled, the processing module disables the pre-alarm function when detecting that the pre-alarm area is clicked; or, the processing module counts clicking times of continuously clicking the pre-alarm area, and enables or disables the pre-alarm function by counting the clicking times.
